(19) United States
(12) Patent Application Publication
(10) Pub. No.: US 2021/0348638 A1
(43) Pub. Date: Nov. 11, 2021

(54) Nut, Fastener Assembly and Fastening Method

(71) Applicants: Tyco Electronics (Shanghai) Co. Ltd., Shanghai (CN); TE Connectivity Services GmbH, Schaffhausen (CH)

(72) Inventors: An Yang, Shanghai (CN); Lvhai Hu, Shanghai (CN); Roberto Francisco-Yi Lu, Bellevue, WA (US)

(73) Assignees: Tyco Electronics (Shanghai) Co. Ltd., Shanghai (CN); TE Connectivity Services GmbH, Schaffhausen (CH)

(21) Appl. No.: 17/313,125

(22) Filed: May 6, 2021

(30) Foreign Application Priority Data
May 8, 2020 (CN) 202010382297.8

(51) Int. Cl. F16B 33/02

(52) U.S. Cl. CPC F16B 33/02

(57) ABSTRACT

A nut adapted to be connected with a bolt includes a through hole defining a first central axis. A first internal thread is formed on an inner peripheral surface of the through hole at a first side of a first end of the through hole. A second internal thread is formed on an inner peripheral surface of the through hole at a second side, opposite to the first side, of a second end of the through hole. The first internal thread and the second internal thread define a second central axis, distinct from the first central axis. The bolt is capable of being positioned in the through hole in a first posture in which the bolt is parallel to the first central axis, and in a second posture in which the bolt is parallel to the second central axis and engaged with the first and second internal threads.

### CROSS-REFERENCE TO RELATED APPLICATIONS

This application claims priority under 35 U.S.C. § 119 to Chinese Patent Application No. 202010382297.8 filed on May 8, 2020, the whole disclosure of which is incorporated herein by reference.

### FIELD OF THE INVENTION

The present disclosure relates to a nut, a fastener assembly comprising the nut and a fastening method for fastening a component with the fastener assembly.

### BACKGROUND

Nuts and bolts are the most commonly used mechanisms for fastening components together. Traditionally, however, a nut and a bolt can only move with respect to each other in a threaded manner. Therefore, when assembling the nut and bolt, it is required to continue rotating the bolt and/or nut until their end surfaces are in contact with the component(s) to be fastened. Likewise, when disassembling the nut and bolt, it is required to continue rotating the bolt and/or nut until they are separated. In this way, the assembly and disassembly of traditional nuts and bolts is time consuming and thus inefficient.

### SUMMARY

According to an embodiment of the present disclosure, a nut adapted to be connected to a bolt includes a through hole defining a first central axis. A first internal thread is formed on an inner peripheral surface of the through hole at a first side of a first end of the through hole. A second internal thread is formed on an inner peripheral surface of the through hole at a second side, opposite to the first side, of a second end of the through hole. The first internal thread and the second internal thread define a second central axis, distinct from the first central axis. The bolt is capable of being positioned in the through hole in a first posture in which the bolt is parallel to the first central axis, and in a second posture in which the bolt is parallel to the second central axis. With the bolt in the first posture, the bolt is not in contact with the first internal thread or the second internal thread such that the bolt is capable of being inserted into or pulled out of the through hole of the nut. With the bolt in the second posture, the bolt is engaged with the first internal thread and the second internal thread such that the bolt and the nut are capable of being threaded together.

### BRIEF DESCRIPTION OF THE DRAWINGS

The invention will now be described by way of example with reference to the accompanying Figures, of which:

FIG. 1 schematically shows a nut according to an exemplary embodiment of the present disclosure;

FIG. 2 illustrates a cross-sectional view of the nut as shown in FIG. 1;

FIG. 3 schematically shows the nut as shown in FIG. 1 and the bolt connected with the nut, wherein the bolt is in the first posture and has not been inserted into the through hole of the nut;

FIG. 4 schematically shows a situation where the bolt inserted into the through hole of the nut is in the first posture;

FIG. 5 schematically shows a situation where the bolt inserted into the through hole of the nut is in the second posture; and

FIG. 6 is a perspective view schematically showing the bolt and the nut which are threaded together.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to a general technical concept of the present disclosure, a nut is provided which is adapted to be connected with a bolt and comprises: a through hole having a first central axis; a first internal thread formed on the inner peripheral surface of the through hole at one side of one end of the through hole; and a second internal thread formed on the inner peripheral surface of the through hole at another side, opposite to the one side, of the other end of the through hole, wherein, the first internal thread and the second internal thread have a second central axis; and an angle between the first central axis and the second central axis is more than zero degrees and less than 90 degrees, so that the bolt is capable of being positioned in the through hole in a first posture in which the bolt is parallel to the first central axis or in a second posture in which the bolt is parallel to the second central axis. When the bolt is in the first posture, the bolt is not in contact with the first internal thread and the second internal thread, so that the bolt is capable of being inserted into or pulled out of the through hole of the nut. When the bolt is in the second posture, the bolt is engaged with the first internal thread and the second internal thread, so that the bolt and the nut are capable of being threaded together

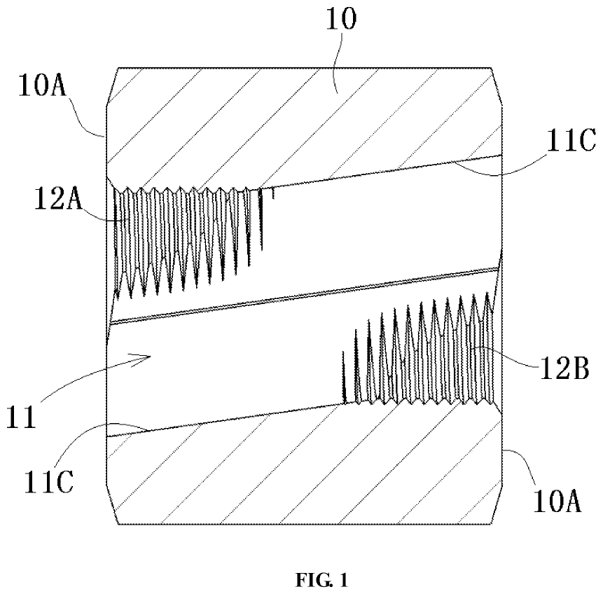

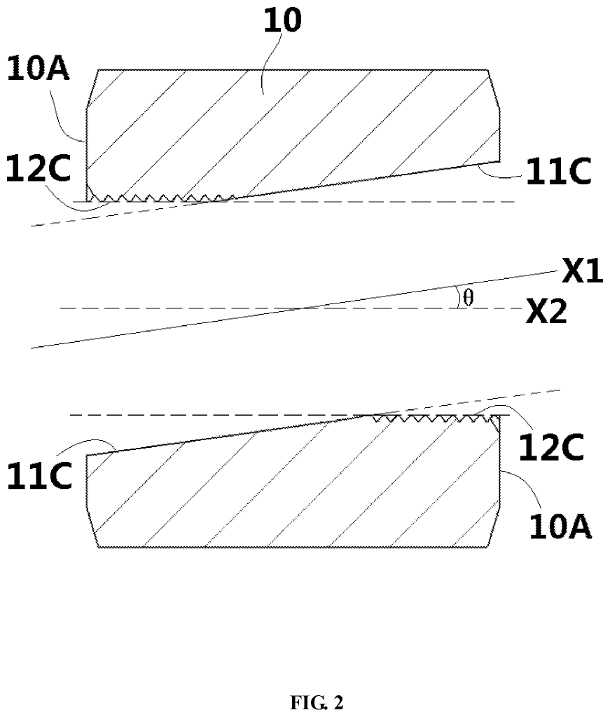

FIG. 1 schematically shows a nut 10 according to an exemplary embodiment of the present disclosure. FIG. 2 illustrates a cross-sectional view of the nut 10 as shown in FIG. 1.

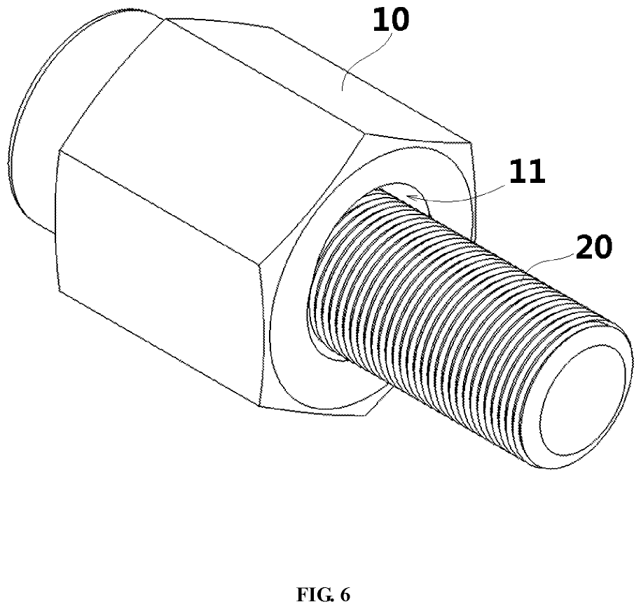

As shown in FIG. 1 and FIG. 2, in the illustrated embodiment, the nut 10 is adapted to be connected with a bolt 20 (see FIG. 6). The nut 10 includes a through hole 11, a first internal thread 12A, and a second internal thread 12B. The through hole 11 of the nut 10 has a first central axis X1. The first internal thread 12A is formed on a partial area of the inner peripheral surface of the through hole 11 that is at one side of one end of the through hole 11. The second internal thread 12B is formed on a partial area of the inner peripheral surface of the through hole 11 that is at another side, opposite to the one side, of the other end of the through hole 11. The first internal thread 12A and the second internal thread 12B have one second central axis X2.

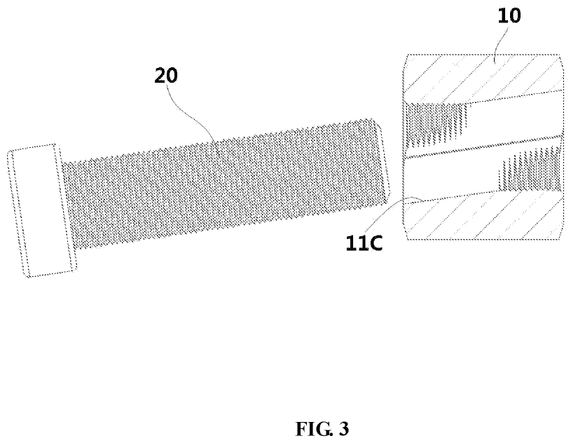

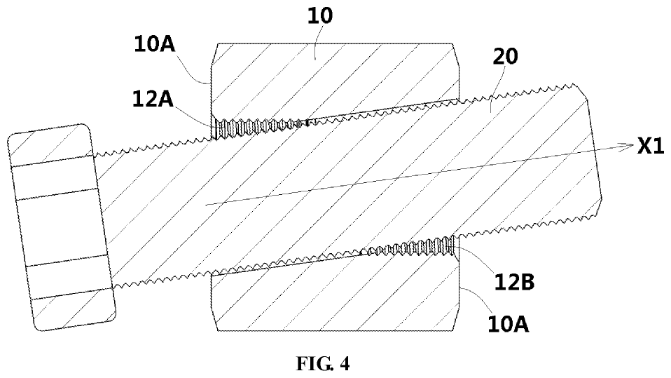

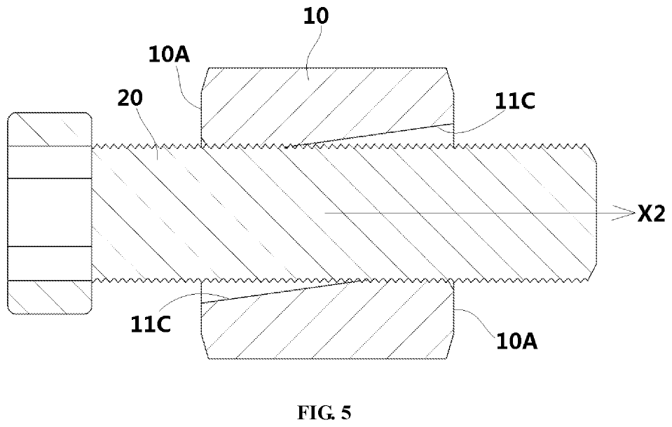

FIG. 3 schematically shows the nut 10 as shown in FIG. 1 and the bolt 20 connected with the nut 10, wherein the bolt 20 is in the first posture and has not been inserted into the through hole 11 of the nut 10. FIG. 4 schematically shows the bolt 20 inserted into the through hole 11 of the nut 10 in the first posture. FIG. 5 schematically shows the bolt 20 inserted into the through hole 11 of the nut 10 in the second posture. FIG. 6 is a perspective view schematically showing the bolt 20 and the nut 10 which are threaded together.

As shown in FIG. 1 to FIG. 6, in the illustrated embodiment, the angle θ between the first central axis X1 and the second central axis X2 is greater than zero degrees and less than 90 degrees, so that the bolt 20 can be arranged in a first posture (as shown in FIGS. 3 and 4) in which the bolt is parallel to the first central axis X1 or in a second posture in which the bolt is parallel to the second central axis X2 (as shown in FIGS. 5 and 6).

As shown in FIG. 1 to FIG. 4, in the illustrated embodiment, when the bolt 20 is in the first posture, the bolt 20 is not in contact with the first internal thread 12A and the second internal thread 12B, so that the bolt 20 can be inserted into or pulled out of the through hole 11 of the nut 10.

As shown in FIGS. 1 and 2 and FIGS. 5 and 6, in the illustrated embodiment, when the bolt 20 is in the second posture, the bolt 20 engages with the first internal thread 12A and the second internal thread 12B, so that the bolt 20 and the nuts 10 can be threaded together.

As shown in FIG. 1 to FIG. 6, in the illustrated embodiment, the size of the area occupied by the first internal thread 12A or the second internal thread 12B in the circumferential direction of the through hole 11 is equal to or less than half of the circumference of the through hole 11.

As shown in FIG. 1 to FIG. 6, in the illustrated embodiment, the size of the area occupied by the first internal thread 12A or the second internal thread 12B in the axial direction of the through hole 11 is equal to or smaller than half of the length of the through hole 11.

As shown in FIG. 1 to FIG. 6, in the illustrated embodiment, the diameter defined by the top 12C of each of the first internal thread 12A and the second internal thread 12B is equal to the diameter defined by the bottom of the external thread of the bolt 20. The diameter defined by the bottom of each of the first internal thread 12A and the second internal thread 12B is equal to the diameter defined by the top of the external thread of the bolt 20.

As shown in FIG. 1 to FIG. 6, in the illustrated embodiment, the area of the through hole 11 other than the area occupied by the first internal thread 12A and the second internal thread 12B has a smooth inner peripheral surface 11C. The diameter defined by the smooth inner peripheral surface 11C is equal to or slightly larger than the diameter defined by the top of the external thread of the bolt 20.

As shown in FIG. 1 to FIG. 6, in the illustrated embodiment, the first central axis X1 intersects the second central axis X2. The intersection of the first central axis X1 and the second central axis X2 is located in the middle position of the nut 10 along its length direction.

As shown in FIG. 1 to FIG. 6, in the illustrated embodiment, the angle θ between the first central axis X1 and the second central axis X2 is within the range of 5-60 degrees.

As shown in FIG. 1 to FIG. 6, in the illustrated embodiment, the angle θ between the first central axis X1 and the second central axis X2 is within the range of 10-30 degrees.

It is noted that the size of the angle θ between the first central axis X1 and the second central axis X2 is not limited to the foregoing embodiments, and can be determined as required.

As shown in FIG. 1 to FIG. 6, in the illustrated embodiment, the end surfaces 10A at both ends of the nut 10 are perpendicular to the second central axis X2.

As shown in FIG. 1 to FIG. 6, in another exemplary embodiment of the present disclosure, a fastener assembly is also disclosed. The fastener assembly mainly includes the aforementioned nut 10 and bolt 20. The bolt 20 is adapted to be threaded with the nut 10.

As shown in FIG. 1 to FIG. 6, in another exemplary embodiment of the present disclosure, a fastening method is also disclosed, which includes the following steps of: S100: providing said fastener assembly; S200: passing the bolts 20 of the fastener assembly through at least two components to be fastened; S300: inserting the bolt 20 directly into the through hole 11 in the nut 10 of the fastener assembly in the first posture until the nut 10 is in contact with the component to be fastened; S400: switching the bolt 20 to be in the second posture by turning the nut 10, such that the first internal thread 12A and the second internal thread 12B on the nut 10 are engaged with the bolt 20; and S500: screwing the bolt 20 or the nut 10 by rotating the bolt 20 or the nut 10 around the central axis of the bolt 20 to fasten at least two components together.

Although not explained explicitly, the method of disassembling the nut 10 and the bolt 20 according to the present disclosure is in a contrary order to the aforementioned fastening method. That is, the disassembling method may include the following steps of: S10: loosening the bolt 20 or the nut 10 by rotating the bolt 20 or the nut 10 around the central axis of the bolt 20; S20: switching the bolt 20 to be in the first posture by turning the nut 10, such that the first internal thread 12A and the second internal thread 12B on the nut 10 are not in contact with the bolt 20; and S30: pulling the bolt 20 directly out from the through hole 11 in the nut 10 in the first posture.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A nut adapted to be connected with a bolt, comprising:
a through hole defining a first central axis;
a first internal thread formed on an inner peripheral surface of the through hole at a first side of a first end of the through hole; and
a second internal thread formed on an inner peripheral surface of the through hole at a second side, opposite to the first side, of a second end of the through hole, the first internal thread and the second internal thread defining a second central axis, distinct from the first central axis, such that that the bolt is capable of being positioned in the through hole in a first posture in which the bolt is parallel to the first central axis or in a second posture in which the bolt is parallel to the second central axis.

2. The nut according to claim 1, wherein:
with the bolt in the first posture, the bolt is not in contact with the first internal thread and the second internal thread such that the bolt is capable of being inserted into or pulled out of the through hole of the nut; and
with the bolt in the second posture, the bolt is engaged with the first internal thread and the second internal thread such that the bolt and the nut are capable of being threaded together.

3. The nut according to claim 2, wherein a size of an area occupied by the first internal thread or the second internal thread in a circumferential direction of the through hole is equal to or less than half of a circumference of the through hole.

4. The nut according to claim 2, wherein a size of an area occupied by the first internal thread or the second internal thread in an axial direction of the through hole is equal to or less than half of a length of the through hole.

5. The nut according to claim 2, wherein a diameter defined by a top of each of the first internal thread and the second internal thread is equal to a diameter defined by a bottom of an external thread of the bolt, and a diameter defined by a bottom of each of the first internal thread and the second internal thread is equal to a diameter defined by a top of an external thread of the bolt.

6. The nut according to claim 2, wherein an area of the through hole other than an area occupied by the first internal thread and the second internal thread has a smooth inner peripheral surface, and a diameter defined by the smooth inner peripheral surface is equal to or greater than a diameter defined by a top of an external thread of the bolt.

7. The nut according to claim 2, wherein the first central axis intersects the second central axis, and an intersection of the first central axis and the second central axis is located in a middle position of the nut along its length direction.

8. The nut according to claim 2, wherein an angle between the first central axis and the second central axis is greater than zero degrees and less than 90 degrees.

9. The nut according to claim 8, wherein the angle between the first central axis and the second central axis is within a range of 5-60 degrees.

10. The nut according to claim 8, wherein the angle between the first central axis and the second central axis is within a range of 10-30 degrees.

11. The nut according to claim 2, wherein end surfaces at both ends of the nut are perpendicular to the second central axis.

12. A fastener assembly, comprising:
a threaded bolt; and
a nut, including:
a through hole defining a first central axis, the bolt being freely insertable through the through hole in a first posture in which an axis of the bolt is parallel to the first central axis;
a first internal thread formed on an inner peripheral surface of the through hole at one side of one end of the through hole; and
a second internal thread formed on another inner peripheral surface of the through hole, the first internal thread and the second internal thread defining a second central axis distinct from the first central axis, the bolt capable of being positioning in the through hole in a second posture in which the bolt is parallel to the second central axis and engaged with the first and second internal threads.

13. The fastener assembly according to claim 12, wherein:
a size of an area occupied by the first internal thread or the second internal thread in a circumferential direction of the through hole is equal to or less than half of a circumference of the through hole; and
a size of an area occupied by the first internal thread or the second internal thread in an axial direction of the through hole is equal to or less than half of a length of the through hole.

14. The fastener assembly according to claim 12, wherein an area of the through hole other than an area occupied by the first internal thread and the second internal thread has a smooth inner peripheral surface, and a diameter defined by the smooth inner peripheral surface is equal to or greater than a diameter defined by a top of an external thread of the bolt.

15. The fastener assembly according to claim 12, wherein the first central axis intersects the second central axis in a middle position of the nut along its length direction.

16. The fastener assembly according to claim 12, wherein end surfaces at both ends of the nut are perpendicular to the second central axis.

17. The fastener assembly according to claim 12, wherein the angle between the first central axis and the second central axis is within a range of 5-60 degrees.

18. A method of fastening a nut and a bolt to a component comprising the steps of:
passing the bolt through the component;
inserting the nut over the bolt, the bolt directly passing into a through hole in the nut in a first posture relative to the nut until the nut is in contact with the component, the through hole defining a first central axis wherein the bolt is capable of being positioned in and passed through the through hole in the first posture in which the bolt is parallel to the first central axis;
orienting the bolt in a second posture relative to the nut by turning the nut such that a first internal thread and a second internal thread of the nut are engaged with the bolt; and
screwing the bolt or the nut by rotating the bolt or the nut around a central axis of the bolt to fastening to the component.

19. The method of claim 18, wherein the step of orienting the bolt in the second posture relative to the nut includes altering an orientation of the nut such that the bolt is non-parallel with respect to the first central axis.

20. The method of claim 18, wherein the first internal thread is formed on an inner peripheral surface of the through hole at one side of one end of the through hole, and the second internal thread is formed on an inner peripheral surface of the through hole at another side, opposite to the one side, of the other end of the through hole, the first internal thread and the second internal thread defining a second central axis, distinct from the first central axis, wherein in the second posture the bolt is parallel to the second central axis.
